(19) United States
(12) Patent Application Publication
(10) Pub. No.: US 2008/0132326 A1
(43) Pub. Date: Jun. 5, 2008

(54) GAMING DISPLAY DEVICE AND METHOD OF USE

(75) Inventors: Jerald C. Seelig, Absecon, NJ (US); Lawrence M. Henshaw, Hammonton, NJ (US)

Correspondence Address: IAN F. BURNS & ASSOCIATES, P.O. BOX 71115, RENO, NV, 89570, US

(73) Assignee: Atlantic City Coin & Slot Service Company, Inc., Pleasantville, NJ (US)

(21) Appl. No.: 12/031,657

(22) Filed: Feb. 14, 2008

Related U.S. Application Data
(63) Continuation-in-part of application No. 10/810,175, filed on Mar. 26, 2004.
(60) Provisional application No. 60/890,163, filed on Feb. 15, 2007.

(51) Int. Cl. A63F 9/24; A63F 13/00

(52) U.S. Cl. 463/20; 463/30; 463/42

(57) ABSTRACT

A gaming display device includes a moveable video display. The moveable video display can display video presentations. An actuator may be coupled to the moveable video display. The actuator is configured to move the moveable video display. A memory device stores several video presentations. A controller is in communication with the moveable video display and the actuator. The controller can select one or more of the video presentations and display the selected video presentation on the moveable video display. The controller can also direct movement of the moveable video display. A method of operating a gaming device including a moveable video display is also provided.

### CROSS REFERENCE TO RELATED AND CO-PENDING APPLICATIONS

This application is a continuation in part of U.S. patent application Ser. No. 10/810,175 filed on Mar. 26, 2004, entitled “Gaming Device Display and Method of Use”.

This application claims priority to U.S. provisional patent application Ser. No. 60/890,163 filed on Feb. 15, 2007, entitled “Gaming Device and Method”. The entire contents of the foregoing applications are herein incorporated by reference.

### BACKGROUND OF THE INVENTION

1. Field of Invention

The present invention relates to gaming devices and, more particularly, to a gaming device and method having a moveable video indicator.

2. Description of the Related Art

Gaming Devices

Gaming devices are well known in the art and a large variety of gaming devices have been developed. In general, gaming devices allow users or players to play a game. In many casino-type gaming devices, the outcome of the game depends, at least in part, on a randomly generated event. For example, a gaming device may use a random number generator to generate a random or pseudo-random number (for convenience, these will both be referred to as “random numbers”). The random number may then be compared to a predefined table to determine the outcome of the event. If the random number falls within a certain range of numbers on the table, the player may win a predefined prize. The table may also contain display information that allows the gaming device to generate a display that corresponds to the outcome of the game. The gaming device may present the outcome of the game on a large variety of display devices, such as mechanical spinning reels or video screens.

Bonus Prizes

Some gaming devices award bonus prizes in addition to prizes that are awarded in the primary game. A bonus prize can be defined as an additional prize that is awarded to the player when a predefined event occurs. An example of a bonus game can be found in U.S. Pat. No. 5,848,932 issued to Adams, which is hereby incorporated by reference. One of the gaming devices described in this document comprises three spinning reels and a spinning wheel bonus display. When predetermined indicia are displayed on the spinning reels of the primary game, the wheel can be activated to indicate a bonus prize. The bonus prize is awarded in addition to any prizes awarded in the primary game.

Generally, bonus prizes are awarded in order to increase the excitement and enjoyment experienced by players, which attracts more players to the game and encourages players to play longer. When this occurs, the gaming devices tend to be more commercially successful relative to other gaming devices. A shortcoming of present bonus games is that they do not sufficiently allow players to participate in the determination of bonus prizes.

Other attempts have been made to provide player interaction. U.S. Pat. No. 5,788,573 to Baerlocher et al. (hereinafter, “Baerlocher”) purports to suggest a gaming device with an electronic “wheel of fortune game.” U.S. Pat. No. 6,309,300 to Glavich (hereinafter, “Glavich”) and U.S. Pat. No. 6,439,995 to Hughs-Baird et al. (hereinafter, “Hughs-Baird”) purport to suggest a gaming system having a bonus feature where a player may be allowed to select a number of selectable items.

Display Devices

Highly visible display devices are utilized on gaming devices in order to attract players. Once players are attracted to the gaming device, they tend to play longer because the display device enhances the stimulation and excitement experienced by players. It is, therefore, desirable for gaming devices to incorporate highly visible display devices.

Display devices may be more successful if they utilize moveable physical objects rather than simulations. Although video devices and electronic signs can be used for display devices, players may be more attracted to display devices that utilize moveable physical objects. Moveable physical objects may be even more effective display devices if the player is allowed to participate in the operation of the object.

### SUMMARY

### 1. Advantages of the Invention

The various embodiments of the present invention may, but do not necessarily, achieve one or more of the following advantages:

provide a highly attractive and entertaining device for displaying bonus prizes;

the ability to provide game players with a more exciting and desirable gaming experience;

the ability to attract more patrons to play a game;

provide a gaming device that can extend play times with a greater payout possibility for a player;

increase revenues for gaming operators;

allow players to participate in the selection of a bonus prize;

provide one or more moveable video displays;

provide a moveable video display that can be positioned adjacent to a stationary video display;

allow players to select either a stationary video display or a moveable video display position;

provide several video presentations that can be shown on a moving video display;

provide a server that can store a large number of video presentations that correspond with a game theme;

allow players to participate in the selection of a bonus prize without affecting the game outcome or any prize that may be awarded;

provide the appearance that the player has control of some part of a bonus game; and

provide for random prize selection while giving the player the illusion of influencing the prize selection.

These and other advantages of the present invention may be realized by reference to the remaining portions of the specification, claims, and abstract.

### 2. Brief Description of Certain Aspects of the Invention

In one embodiment, the present invention is directed to a gaming device. The gaming device can include at least one game apparatus that may allow a player to place a wager and play a game. The game apparatus is configured to produce a bonus-activating event.

In an embodiment, the present invention provides a gaming device that includes a moveable video display. The moveable video display can display video presentations. An actuator may be coupled to the moveable video display. The actuator is configured to move the moveable video display. A memory device stores several video presentations. A controller is in communication with the moveable video display and the actuator. The controller can select one or more of the video presentations and display the selected video presentation on the moveable video display. The controller can also direct movement of the moveable video display.

In another embodiment, the present invention is directed to a method of operating a gaming device. The method includes displaying a first video presentation on a moveable video display. The movable video display is moved and then stopped. A second video presentation is displayed on a stationary video display. The moveable video display can be mounted adjacent to the stationary video display.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

FIG. 1 is substantially a front view of a gaming device of one embodiment of the present invention.

FIG. 2 is substantially a partial cross-sectional view of the gaming device of FIG. 1.

FIG. 3 is substantially a diagrammatic view of a gaming network of one embodiment of the present invention.

FIG. 4 is substantially a front view of FIG. 1 showing one possible embodiment of a game display.

FIG. 5 is substantially a flow chart of one embodiment of a method of operation of the gaming device of FIG. 1.

FIG. 6 is substantially a front view of an alternative embodiment of a gaming device of the present invention.

FIG. 7 is substantially a front view of the gaming device of FIG. 6 showing one possible embodiment of a game display.

FIG. 8 is substantially a front view of the gaming device of FIG. 6 showing another game display.

FIG. 9 is substantially a flow chart of one embodiment of a method of operation of the gaming device of FIG. 6.

### DETAILED DESCRIPTION OF AT LEAST ONE EMBODIMENT OF THE INVENTION

In the following detailed description of at least one embodiment of the invention, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

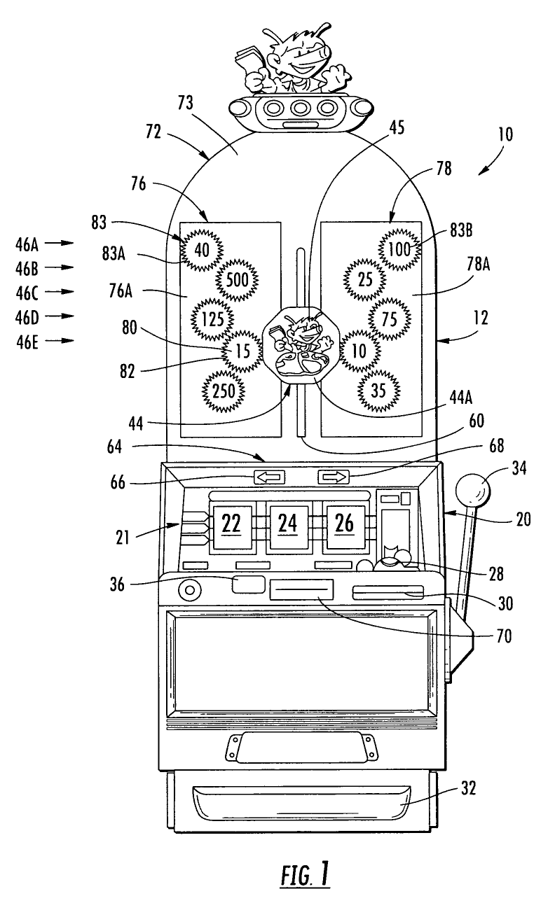

As seen in FIG. 1, the present invention comprises a gaming device, generally indicated by reference number 10. In an embodiment, the gaming device 10 comprises a bonus display or bonus display device 12 and a base or primary game apparatus 20.

Game Apparatus

With continuing reference to FIG. 1, the base or primary game apparatus 20 may be any of a large number of devices that are adapted to allow players to play a base or primary game. For example, the base or primary game apparatus 20 may include a gaming outcome display 21 that utilizes spinning reels 22, 24, and 26 or a video display (not shown) to display outcomes of the game. A value acceptor, such as a coin slot 28 or a card reader 30, may also be provided for accepting value from a player. In addition, a payout mechanism, such as a coin dispenser 32, may be provided for awarding prizes. A handle 34 and a button 36 are provided for activating the base or primary game apparatus 20 to begin a game. In at least one embodiment, the base or primary game apparatus 20 may be an S Plus model gaming device manufactured by International Game Technology in Reno, Nev.

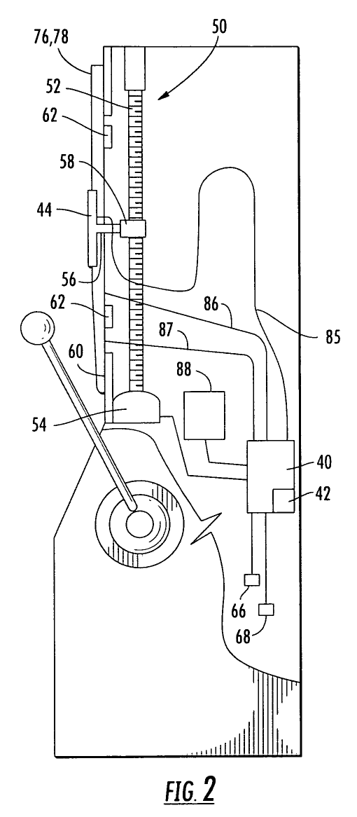

Referring also to FIG. 2, the base or primary game apparatus 20 can be controlled by an electronic controller 40 that utilizes a random number generator 42. The random number generator 42 produces a random or pseudo random number for each game. The outcome of the game may be determined by comparing the random number to a table of outcomes stored in a memory and accessed by the electronic controller 40. A number of different tables of outcomes may be used and different tables may be used for different games. The tables can be designed so that different prizes have different probabilities of being awarded. Such design techniques are well known in gaming. Examples of such designs are shown in U.S. Pat. No. 4,448,419, issued to Telnaes, and U.S. Pat. No. 5,456,465, issued to Durham. The electronic controller 40 causes gaming outcome display 21 (FIG. 1), e.g., the spinning reels 22, 24, and 26, to show the outcome of the game that corresponds to the outcome determined by the random number generator 42. It is recognized that the base or primary game apparatus 20 may operate in many other ways and still achieve the objects of the present invention.

The base or primary game apparatus 20 may further include a memory device 88 that is in communication with the electronic controller 40. The memory device 88 may be any suitable storage device such as a hard disc drive, random access memory (RAM), or CD-ROM device. Memory device 88 may be used to store various game parameters and information such as music, audio sounds and video presentations.

The base or primary game apparatus 20 may also be capable, via the electronic controller 40 or another bonus control mechanism (not shown), of producing a bonus-activating event. This event may be many different types of events. For example, the bonus-activating event may comprise a game outcome, such as displaying a particular symbol, e.g., a “bonus” symbol, or combination of symbols, such as three “7” symbols on the spinning reels 22, 24, and 26. If the game being played is poker based, the bonus-activating event may be an occurrence of a certain hand, such as a royal flush. Furthermore, the bonus-activating event may occur when a player accumulates a number of symbols or game outcomes over a number of separate game plays. For example, a bonus-activating event may occur when the player receives three “bonus” symbols during a period of time. The bonus-activating event may be based on an external event. For example, the bonus-activating event may occur when a group of players obtain a certain result.

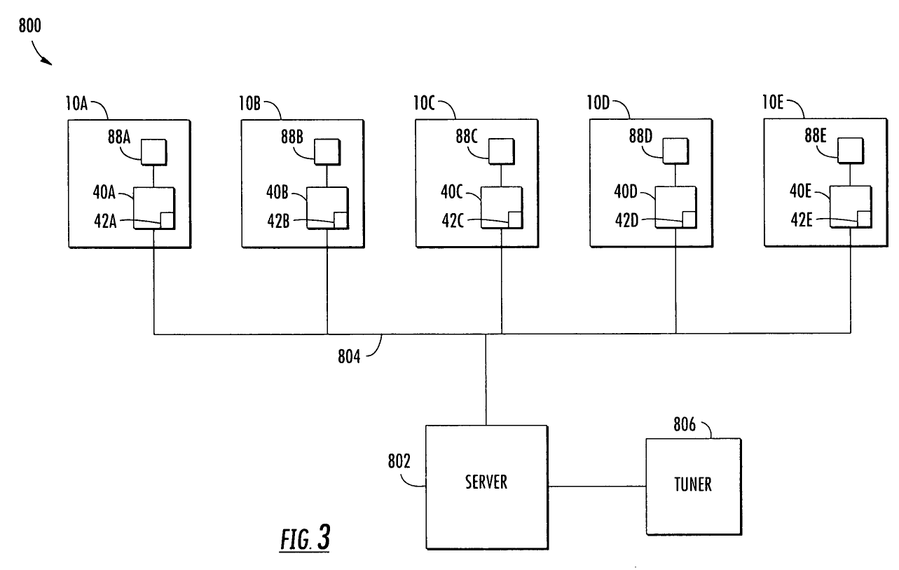

Referring now to FIG. 3, a gaming system or gaming network 800 of several interconnected gaming devices 10 including gaming devices 10A, 10B, 10C, 10D and 10E are shown. The gaming network 800 includes gaming devices 10A-E that are connected to a server 802 by an electrical cable 804. The server 802 can be a conventional computer server and storage devices or a game control computer system. The server 802 can store a wide variety of game information and video presentations. The server 802 may also include a player tracking database that records the actual game play of game players. The electrical cable 804 can be a wide variety of cables such as Ethernet or local area network cables. Alternatively, the gaming devices 10 could be connected to the server 802 using wireless communications.

The server 802 facilitates communication between gaming devices 10A-E. While five gaming devices 10 were shown in communication with the server 802, more or fewer gaming devices 10 could be utilized. The server 802 can further be in communication with a tuner 806. The tuner 806 can receive video presentations from a video source for storage on the server 802. The tuner 806 may receive video presentations from a cable network, RF signal or any other suitable network. Alternatively, the server 802 may store or be programmed to create a large number of video presentations.

Each of the gaming devices 10A-E can request game information or a game outcome from server 802. The server 802 can transmit game information including video presentations to one or more of the gaming devices 10A-E. The server 802 can control the determination of any game outcome or prize. The controllers 40A-E may be in communication with random number generators 42A-E. The controllers 40A-E can receive game information and video presentations from the server 802 and store the game information and video presentations on memory devices 88A-E.

The electronic controller 40 may allow a game player to select a game theme or content to be downloaded from the server 802 and shown during the game. For example, the electronic controller 40 may present the game player with a selection menu that allows the game player to select a game theme. The game theme could include a wide variety of topics such as sporting events, movies, celebrities, musicians or cartoons. Alternatively, the electronic controller 40 and the sever 802 could automatically select the theme of the game using previously stored player preference or tracking information.

In another embodiment, the server 802 may store game information and the electronic controller 40 may be configured to receive the game information from the server 802 and to select the selected video presentation to be presented based on the game information.

Bonus Display

Referring again to FIG. 1, the bonus display device or bonus display 12 can include a housing 72 having a front panel 73. A pair of stationary video displays 76 and 78 can be mounted on the front panel 73. The stationary video displays 76 and 78 can be any display that can show video presentations. The stationary video displays 76 and 78 can be liquid crystal (LCD), plasma, electro-luminescent or cathode ray tube (CRT) type video displays. The stationary video display 76 has a front surface 76A and the stationary video display 78 has a front surface 78A. In another embodiment, the stationary video displays 76 and 78 could be made to move or be moveable.

The stationary video displays 76 and 78 can show a wide variety of video presentations. The video presentations may be an entertaining video presentation and can be related to a theme of the game. For example, the video presentations may be related to a sporting event, a cartoon, a movie, a television show or a music video. When the gaming device 10 is not being played, the stationary video displays 76 and 78 may operate in an attract mode and display a video presentation in order to draw attention to the gaming device 10.

As part of the video presentation, the stationary video displays 76 and 78 can display various symbols or indicia 80 in various prize positions 82. The indicia 80 may represent various things, including prize amounts, multipliers, a description or representation of merchandise or services, progressive prizes, or jackpot prizes. The indicia 80 may be moved or scrolled if desired. In FIG. 1, the indicia 80 are shown arranged in horizontally aligned bonus prize pairs or sets 83. For example, one of the bonus prize sets 83 can include one indicia shown in a position 83A on the stationary video display 76 and one indicia shown in a position 83B on the stationary video display 78.

The bonus display or bonus display device 12 is adapted to select a bonus prize and display the prize to a player. When the bonus display or display device 12 is informed that the bonus-activating event has occurred, the bonus display or display device 12 causes a moveable video indicator or display 44 to move linearly (in this case vertically) to a selected height. In other embodiments, the moveable video indicator or display 44 may move horizontally, diagonally, in a zigzag path, in a circular path, in a spiral path or in a variable path or in a wide variety of motions.

The moveable video indicator or display 44 can be any display that can show video presentations. The moveable video indicator or display 44 can be any suitable video display such as liquid crystal (LCD), plasma, electro-luminescent or cathode ray tube (CRT) type video displays. The moveable video indicator or display 44 has a front surface 44A. In another embodiment, the moveable video indicator or display 44 may be stationary.

The moveable video indicator or display 44 can show a wide variety of video presentations. The video presentations may be an entertaining video presentation and can be related to a theme of the game. For example, the video presentations may be related to a sporting event, a cartoon, a movie, a television show or a music video. When the gaming device 10 is not being played, the moveable video indicator or display 44 may operate in an attract mode and display a video presentation in order to draw attention to the gaming device 10. The moveable video indicator or display 44 may display a space ship 45 in one video presentation.

The movable video indicator or display 44 can have a plurality of stop positions (levels) provided, and each stop position can indicate one of the pluralities of bonus prize sets 83. Each bonus prize set 83 includes at least two bonus prizes, (shown by symbols indicia 80), in positions 83A and 83B, which are displayed adjacent moveable video indicator or display 44.

In the example shown in FIG. 1, there are five different prize levels or vertical stop positions 46A, 46B, 46C, 46D and 46E. Each vertical stop positions 46A-E indicates two bonus prizes. The moveable video-indicator or display 44 is shown stopped at vertical stop position 46D adjacent to and indicating the bonus prize sets 83 having the symbols or indicia 80 with a value of “15” and “10”.

The movable video indicator or display 44 is illustrated showing a video presentation on the stationary video displays 76 and 78 of a space ship with an alien pilot and the prize positions 82 that appear to be planets or stars. However, many other shapes and objects may be shown on the video displays 44, 76 and 78.

As shown in FIG. 2, the movable video indicator or display 44 is made to move up and down by a positioning device, apparatus mechanism or drive mechanism 50. The positioning or drive mechanism may be a large variety of different devices. For example, as shown in FIG. 2, the drive mechanism 50 may be a vertically positioned worm gear 52 that is caused to rotate by a rotary electric motor or actuator 54. The electronic controller 40 is in communication with and can control the operation of the actuator 54.

The moveable video indicator or display 44 may be attached to the worm gear 52 by a bracket 56 that is attached to a nut 58 threaded on the worm gear 52. A slot 60 (best shown in FIG. 1) may be provided in the front panel 73 of bonus display 12, which allow the bracket 56 to pass through the face. Sensors 62 may be provided to allow the electronic controller 40, or other bonus control mechanisms (not shown), to detect the position of the moveable video indicator or display 44. While the moveable video indicator or display 44 was shown to move vertically, it may also be moved horizontally, or diagonally or in a non-linear fashion such as in rotating manner.

The moveable video indicator or display 44 can be electrically connected or in communication with the electronic controller 40 through a flexible electrical cable 85. Alternatively, the electronic controller 40 may be in communication with the moveable video indicator or display 44 through wireless communications using a transmitter and receiver. The flexible cable 85 allows the moveable video indicator or display 44 to freely move while being connected to the electronic controller 40. An electrical cable 86 connects the stationary video display 76 to the electronic controller 40. An electrical cable 87 connects the stationary video display 78 to the electronic controller 40.

In one embodiment of the present invention, the player is given the opportunity to select one of the stationary video displays 76 or 78 to display a prize or game outcome. In the exemplary display shown in FIG. 1, the user may select either the left stationary video display 76 or the right stationary video display 78.

The player may indicate his or her choice by making a selection via one or more selectors or player input devices, which may take a variety of forms. In one embodiment, shown in FIG. 1, a player input device 64 includes a button 66 and a button 68 that allows the player to select the corresponding prize display. The button 66 and the button 68 may be in communication with the electronic controller 40 (FIG. 2). For example, the player would press the left button 66 to select the left stationary video display 76. The right button 68 would select the right stationary video display 78. Alternatively, a touch screen (not shown) may be provided in place of or in addition to the button 66 and the button 68. The selector may be any other known or later developed mechanism for selecting between two items. In an alternative embodiment, the player may not be allowed to make a selection using the player input device 64 and the electronic controller 40 may automatically make all selections.

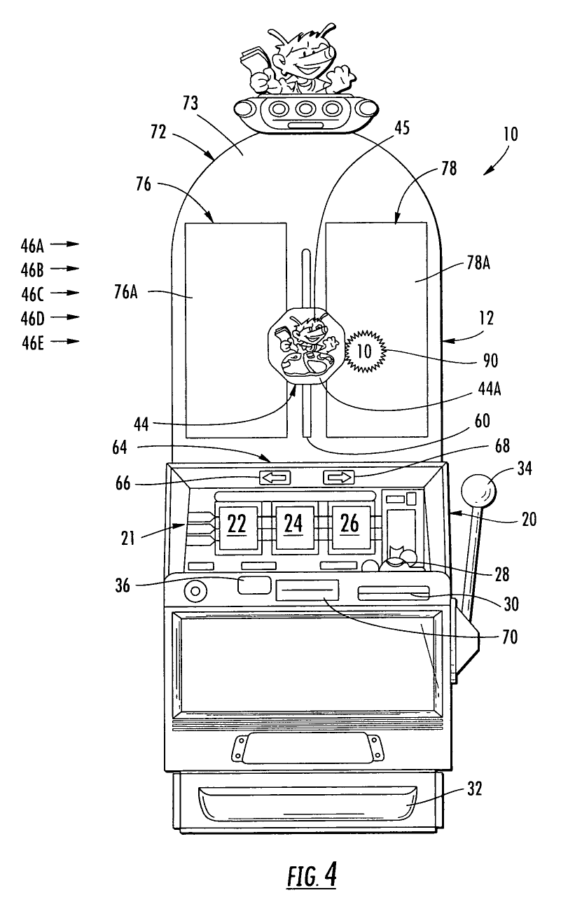

Once the player has selected a stationary video display, the electronic controller 40 may direct moveable video indicator or display 44 to stop at one of the vertical step positions 46A-E adjacent the prize positions 82 and present a video presentation on the stationary video display that indicates one or more bonus prizes won by the player. For instance, as shown in FIG. 4, the player has selected stationary video display 78 using the button 68. The electronic controller 40 has directed moveable video indicator or display 44 to stop at the prize level 46D and further has recalled a video presentation from the memory device 88 to be shown on the stationary video display 78 selected by the player and on the moveable video indicator or display 44. FIG. 4 shows the combination of the moveable video indicator or display 44 and the stationary video display 78 indicating to a game player a bonus prize or game outcome 90 having a value of “10” credits. At the same time an entertaining video presentation may be shown on the stationary video display 78 or the moveable video indicator or display 44 as part of the indication of a prize or award. Any credits won may be added to the game player's credit meter.

Therefore, the gaming device 10 allows a game player to determine which stationary video display 76 or 78 will display the game outcome, while the electronic controller 40 selects the stop position for the moveable video indicator or display 44 to indicate the game outcome.

In one embodiment, the bonus prizes are randomly generated. The electronic controller 40 generates a random number for each bonus prize to be awarded, and then compares the random number to a pay table similar to that described for the base or primary game apparatus 20 or as described in U.S. Pat. No. 5,823,874, issued to Adams, which is hereby incorporated by reference. A simple pay table may appear as follows:

| Random | Amount |
|---|---|
| Number | Paid |
| 0.00 to 0.50 | $1.00 |
| 0.51 to 0.75 | $5.00 |
| 0.76 to 0.95 | ×2 |
| 0.96 to 1.00 | $1,000.00 |

For example, if the random number generator 42 produced a value of 0.65, $5.00 would be awarded to the player. If the random number generator 42 produced a value of 0.80, the player would receive a multiplier of 2. The multiplier multiplies some amount produced by the base or primary game apparatus 20. The base or primary gaming apparatus 20, for instance, may award $20 and the multiplier would multiply this by two, awarding the player $40.

The bonus selection process may be repeated to accumulate several bonus prize selections that are added to form the award to the game player. The bonus selection process can be repeated a pre-determined number of times. For example, the bonus game could be repeated three times to accumulate an award.

The present invention is not limited to the example pay table shown. Furthermore, different kinds of bonus prizes, besides monetary prizes, may be awarded. For example, the bonus prizes may be goods, services, or additional games. The bonus prize could be a jackpot prize, a progressive prize, or a prize determined by a plurality of networked gaming devices.

Once the electronic controller 40 (FIG. 2) or the server 802 (FIG. 3) determines the bonus prizes to be awarded, the electronic controller 40 causes the appropriate stationary video display to display the prizes after the player has selected one of the displays using player input devices 66 or 68.

Other effects may also be presented, such as pre-recorded sound from speakers. If the actual bonus prize is money, the amount of the bonus prize may be added to the player's credit meter (not shown) or the bonus prize may be dispensed from a dispenser 70 or the coin dispenser 32.

Game Method

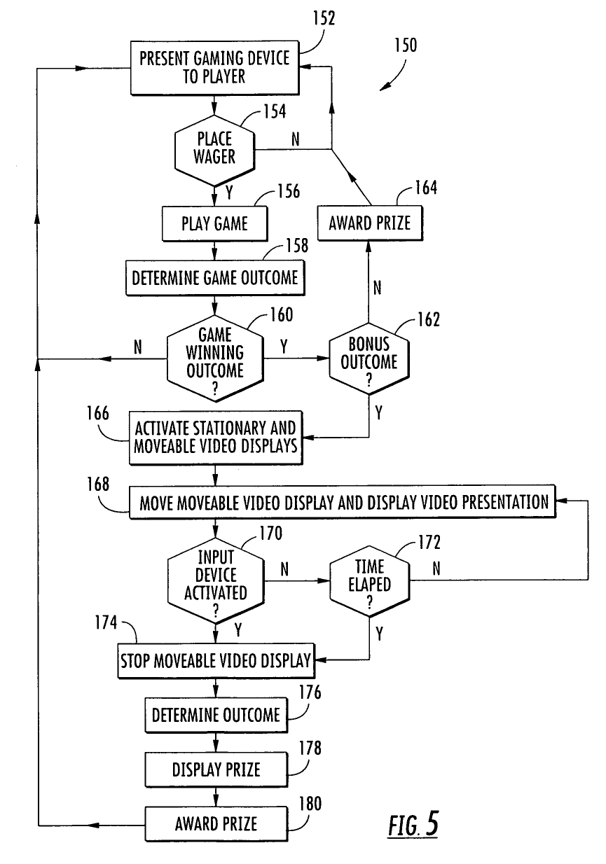

Turning now to FIG. 5 and with reference to FIG. 1, a flowchart illustrating one possible embodiment of a method of operation of the gaming device 10 depicted in FIGS. 1-4 is shown. The method, generally referred to as method 150, begins by presenting a base or primary gaming device to a player at step 152. Decision 154 then determines if the player has placed a wager. If no wager has been placed, the method 150 returns to step 152 until a wager is placed.

If a wager has been placed at decision 154, the player may activate the gaming device and play a base game at step 156. The base game outcome is determined at step 158. Decision 160 checks to see if the base game outcome is a winning outcome.

If decision 160 determines that step 158 resulted in a losing outcome, the method 150 returns to step 152. If decision 160 determines that step 158 resulted in a game winning outcome, method 150 proceeds to decision 162. Decision 162 determines whether the game outcome is a bonus activating outcome. If the game outcome from step 158 is not a bonus activating outcome, method 150 awards any prizes to which the player is entitled at step 164 and then returns to step 152.

If decision 162 determines that game outcome 158 is a bonus activating outcome, method 150 activates the bonus display 12 at step 166, enabling the player input device 64, the stationary video displays 76 and 78 and the moveable video indicator or display 44. At step 168, the moveable video indicator or display 44 is moved and a video presentation is shown on the moveable video indicator or display 44. The stationary video displays 76 and 78 may also start to display a video presentation at step 168. The moveable video indicator or display 44 may move in a variety of ways. For example, the moveable video indicator or display 44 may move all the way up the slot 60 (FIG. 1) and then all the way down, then back up, and so on. Alternatively, the moveable video indicator or display 44 may move randomly or at more than one speed. A video presentation may also be started on the moveable video indicator or display 44.

Next, the method 150 proceeds to decision 170, which ascertains whether the player has activated the player input device 64 to select either the stationary video display 76 or the stationary video display 78. If the player has not activated the player input device 64, the method 150 may proceed to step 172. At step 172, the method 150 checks to see if any preset time period has elapsed. For example, the game developer may limit the time period to thirty seconds. Once the time period elapses, moveable video indicator or display 44 will automatically stop. If this time period has not elapsed, the method 150 returns to step 168 and continues movement of moveable video indicator or display 44.

If the player has activated the player input device 64 at decision 170, or the time limit has expired in decision 172, method 150 proceeds to step 174. At step 174, the moveable video indicator or display 44 is stopped. The bonus game outcome is determined at step 176 and any prize the player has won is displayed or indicated by a video presentation on the selected stationary video display 76 or 78 adjacent to the stopped moveable video indicator or display 44 at step 178. The player is then awarded the prize at step 180 and then method 150 returns to step 152.

Many other methods may be used to operate the present invention. For example, the order of the steps in FIG. 5 may be altered or interchanged. In one embodiment, the input device may be activated prior to activating the video displays. In another embodiment, a player may be allowed to select the theme of a video presentation shown on video displays 44, 76 or 78.

Alternate Bonus Display Embodiment

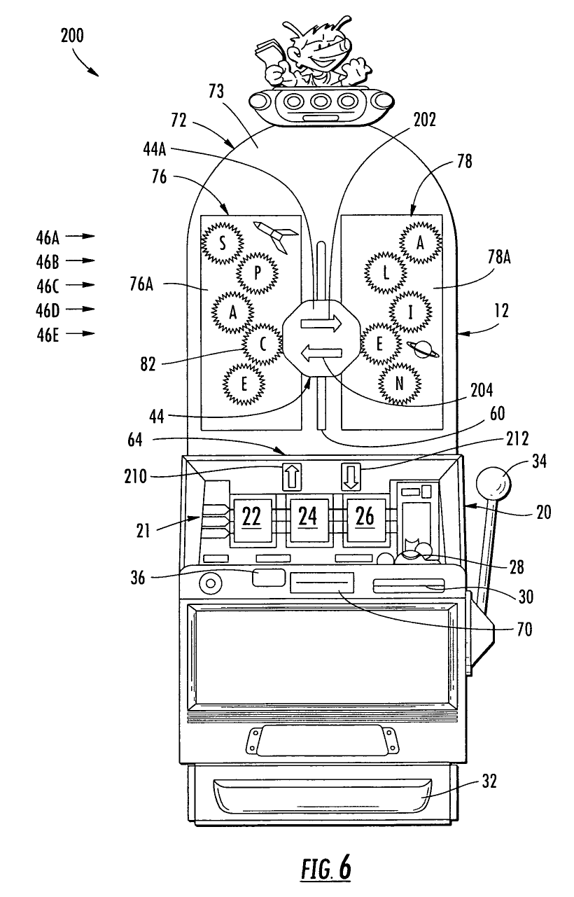

With reference now to FIG. 6, an alternate embodiment of the present invention is shown. A gaming device 200 shown in FIG. 6 is similar to the gaming device 10 previously described in FIGS. 1 and 2. The gaming device 200 includes a pair of player input devices 64 such as selector buttons 210 and 212. Buttons 210 and 212 can allow a game player to select the position of, or move and stop the movement of, the moveable video indicator or display 44. Buttons 210 and 212 are in communication with the electronic controller 40 (FIG. 2). When button 210 is depressed a first time, the moveable video indicator or display 44 may move upward. A second depression of button 210 may stop the moveable video indicator or display 44. When button 212 is depressed a first time, the moveable video indicator or display 44 may move downward. A second depression of button 212 may stop the moveable video indicator or display 44. Buttons 210 and 212 allow a game player to select one of the vertical stop positions 46A-E to stop. Input from player input devices 64 can allow a player to at least partially control the movement of the moveable video indicator or display 44.

The moveable video indicator or display 44 may show a video presentation that can include a pair of arrows. Right arrow 202 points towards the stationary video display 78 and left arrow 204 points toward the stationary video display 76.

The stationary video displays 76 and 78 may show a video presentation as directed by the electronic controller 40 at the same time that moveable video indicator or display 44 moves up and down. The stationary video displays 76 and 78 may include prize symbols or positions 82.

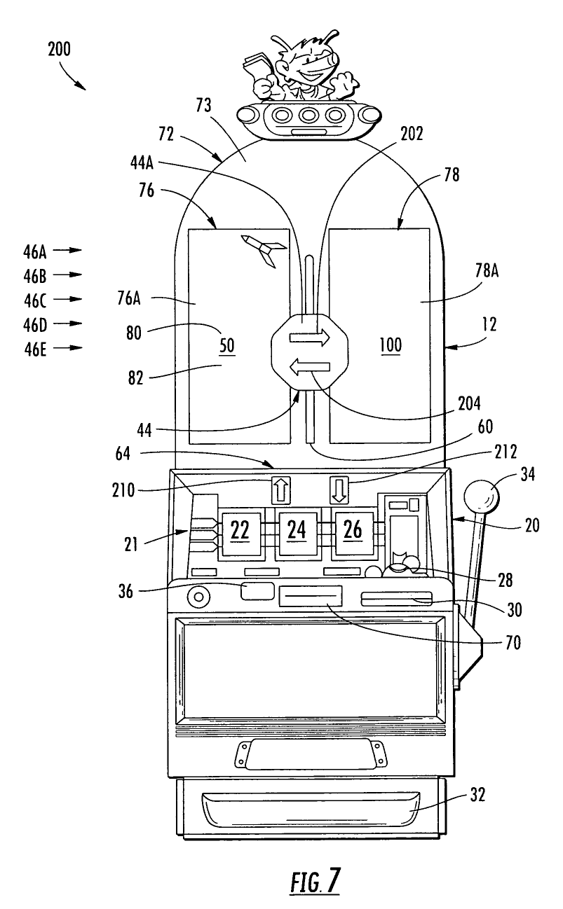

Turning now to FIG. 7, the gaming device 200 is shown after the game player has stopped moveable video indicator or display 44 at a certain vertical height. In FIG. 7, moveable video indicator or display 44 is shown stopped at vertical stop position 46D. The stationary video display 76 can display a video presentation with indicia 80 showing a possible award of 50 credits. The stationary video display 78 can display a video presentation with the indicia 80 showing a possible award of 100 credits.

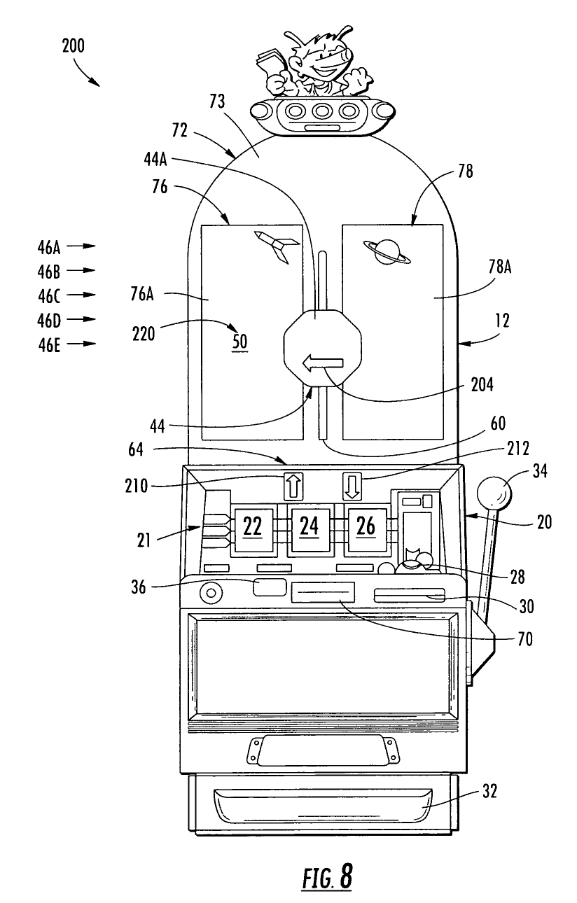

FIG. 8 shows the game outcome or final prize awarded by the gaming device 200. In FIG. 8, the electronic controller 40 has directed video presentations to be shown on the stationary video display 76 and the moveable video indicator or display 44. The moveable video indicator or display 44 is shown displaying a left arrow 204 that is pointing to a game outcome 220 of 50 credits on the stationary video display 76.

The gaming device 200 may allow a game player to determine the stop position of the moveable video indicator or display 44, while the electronic controller 40 selects which stationary video displays 76 or 78 will display the game outcome. The game outcome is indicated by the combination of the moveable video indicator or display 44 and one of stationary video displays 76 or 78.

Game Method of the Alternative Embodiment

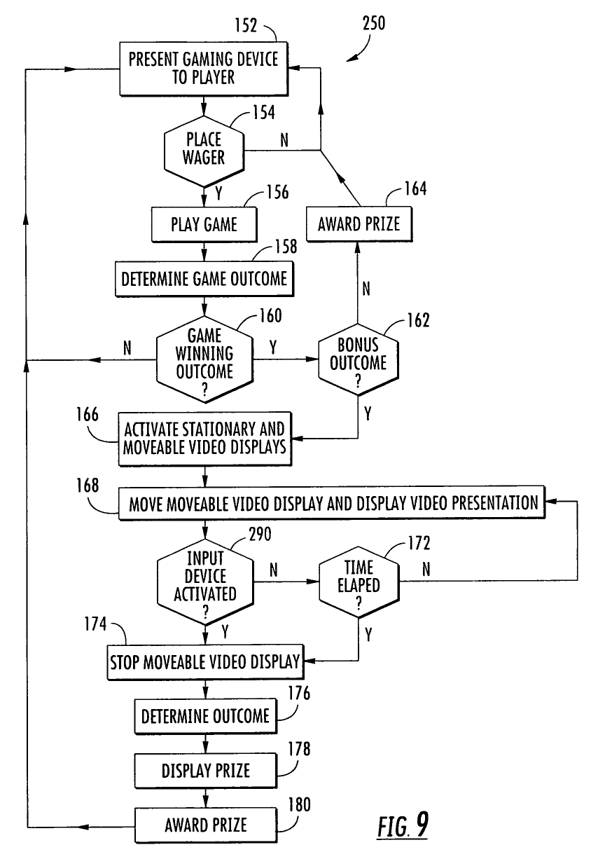

Referring to FIG. 9 and with continued reference to FIGS. 6-8, a flowchart illustrating one embodiment of a possible method of operation of the gaming device 200 depicted in FIGS. 6-8 is shown. The method, generally referred to as 250, begins by presenting a base or primary gaming device to a player at step 152. Decision 154 then determines if the player has placed a wager. If no wager has been placed, the method 250 returns to step 152 until a wager is placed.

If a wager has been placed at decision 154, the player may activate the base gaming device and play a base game at step 156. The game outcome is determined at step 158. Decision 160 checks to see if the game outcome is a winning outcome.

If decision 160 determines that step 158 resulted in a losing outcome, method 250 returns to step 152. If decision 160 determines that step 158 resulted in a game winning outcome, the method 250 proceeds to decision 162. Decision 162 determines whether the game outcome is a bonus activating outcome. If the game outcome from step 158 is not a bonus activating outcome, the method 250 awards any prizes to which the player is entitled at step 164 and then returns to step 152.

If decision 162 determines that game outcome 158 is a bonus activating outcome, the method 250 activates the bonus display 12 at step 166, enabling the player input device 64 including the buttons 210, 212, the stationary video displays 76 and 78 and the moveable video indicator or display 44. At step 168, the moveable video indicator or display 44 can display a video presentation. The video displays 76 and 78 may also start to display a video presentation at step 168. The moveable video indicator or display 44 may move in a variety of ways. For example, the moveable video indicator or display 44 may move all the way up the slot 60 (FIG. 1) and then all the way down, then back up, and so on. Alternatively, the moveable video indicator or display 44 may move randomly or at more than one speed. A video presentation may be started to display on the moveable video indicator or display 44.

Next, method 250 proceeds to decision 270, which ascertains whether the player has activated player input devices 210 or 212 in order to select a stop position for the moveable video or indicator display 44. If the player has not activated the player input device, the method 250 may proceed to step 172. At step 172, the method 250 checks to see if any preset time period has elapsed. For example, the game developer may limit the time period to thirty seconds. Once the time period elapses, the moveable video indicator or display 44 will automatically stop. If this time period has not elapsed, the method 250 returns to step 168 and continues movement of the moveable video indicator or display 44.

If the player has activated one of player input devices 210 or 212 at decision 270, or the time limit has expired in decision 172, method 250 proceeds to step 174. At step 174, the moveable video indicator or display 44 is stopped. The bonus game outcome is determined at step 176 and any prize the player has won is indicated by a video presentation on stationary video displays 76 or 78 and the moveable video indicator or display 44 at step 178. This may include displaying a left or right arrow on the moveable video indicator or display 44 as shown in FIG. 8. The player is then awarded the prize at step 180 and then method 250 returns to step 152.

Many other methods may be used to operate the present invention. For example, the order of the steps in FIG. 9 may be altered or interchanged. In one embodiment, the input device could be activated prior to activating the video displays. In another embodiment, a player may be allowed to select the theme of a video presentation shown on video displays 44, 76 or 78.

### CONCLUSION

Although the description above contains many specifications, these should not be construed as limiting the scope of the invention but as providing illustrations of some embodiments of this invention. Thus, the scope of the invention should be determined by the appended claims and their legal equivalents rather than by the examples given.

What is claimed is:

1. A gaming device comprising:
(A) at least one moveable video display, the moveable video display being configured to display video presentations;
(B) at least one actuator coupled to the moveable video display, the actuator being configured to move the moveable video display;
(C) at least one memory device configured to store a plurality of video presentations; and
(D) at least one controller in communication with the moveable video display, the memory device and the actuator, the controller being configured to select a video presentation from the plurality of video presentations and cause the moveable video display to display the selected video presentation and configured to cause the actuator to move the moveable video display.

2. The gaming device of claim 1, further comprising at least one stationary video display positioned adjacent to the moveable video display, the stationary video display being configured to display a second video presentation, the actuator being configured to move the moveable video display relative to the stationary video display.

3. The gaming device of claim 1, further comprising a player input device in communication with the controller, wherein when a player activates the player input device, the controller is configured to cause the actuator to stop movement of the moveable video display.

4. The gaming device of claim 1, wherein the controller is in communication with a server having game information, wherein the controller is configured to receive the game information from the server and to select the selected video presentation based on the game information.

5. The gaming device of claim 2, further comprising a player input device in communication with the controller, wherein the player is allowed to select at least one of the stationary video displays using the player input device.

6. The gaming device of claim 2, wherein the stationary video display is in communication with the controller, the controller being in communication with a server having game information, wherein the controller is configured to receive the game information from the server and to select and display the second video presentation on the stationary video display.

7. The gaming device of claim 1, wherein the movable video display is in communication with the controller through a flexible cable.

8. The gaming device of claim 2, wherein in combination, the movable video display and the stationary video display indicate a game outcome.

9. A gaming system, comprising:
(A) a gaming device, comprising:
(a) at least one moveable video display, the video display being configured to display video presentations;
(b) at least one actuator coupled to the moveable video display, the actuator being configured to move the moveable video display; and
(c) at least one controller in communication with the moveable video display and the actuator, the controller being configured to select a video presentation from a plurality of video presentations and to cause the moveable video display to display the selected video presentation, the controller further causing the actuator to move the moveable video display; and
(B) a server in communication with the gaming device, the server being configured to store game information, wherein the controller is configured to receive the game information from the server and to select the selected video presentation based on the game information.

10. The gaming system of claim 9, further comprising at least one stationary video display positioned adjacent to the moveable video display, the stationary video display being configured to display a second video presentation, the actuator being configured to move the moveable video display relative to the stationary video display.

11. The gaming system of claim 9, further comprising a player input device in communication with the controller, wherein when a player manipulates the player input device, the controller is configured to control the moveable video display according to input from the player input device.

12. The gaming system of claim 10, further comprising a player input device in communication with the controller, wherein the player is allowed to select at least one of the stationary video displays using the player input device.

13. The gaming system of claim 10, wherein the stationary video display is in communication with the controller, the controller being adapted to receive the game information from the server and to select and display the second video presentation on the stationary video display.

14. A method of operating a gaming device, comprising, but not necessarily in the order shown:
(A) displaying a first video presentation on a moveable video display;
(B) moving the moveable video display;
(C) stopping the moveable video display; and
(D) displaying a second video presentation on a stationary video display.

15. The method of claim 14 further comprising:
(A) allowing a game player to stop the moveable video display.

16. The method of claim 14 further comprising:
(A) providing a plurality of stationary video displays; and
(B) allowing a game player to select at least one of the stationary video displays.

17. The method of claim 14 further comprising:
(A) indicating a prize by the combination of the first and second video presentations.

18. The method of claim 14 further comprising:
(A) receiving game information from a server; and
(B) selecting the first video presentation based on the game information.

19. A gaming device comprising:
(A) a moveable video display means for displaying a plurality of video presentations;
(B) a positioning means for moving the moveable video display means; and
(C) a controller means, in communication with the moveable video display means and the positioning means, for selecting at least one of the video presentations, for displaying a first video presentation on the moveable video display means, and for controlling the positioning means to move the moveable video display means.

20. The gaming device of claim 19, further comprising a memory means for storing the video presentations.

21. The gaming device of claim 19, further comprising a stationary video display means for displaying a second video presentation, the stationary video display means positioned adjacent to the moveable video display means.

22. The gaming device of claim 19, further comprising player input means for allowing a player to make a selection, the player input means in communication with the controller means.

23. The gaming device of claim 19, further comprising a server means for storing game information, the controller means being in communication with the server means, wherein the controller means receives the game information from the server means and selects the selected video presentations based on the game information.

24. A gaming device comprising:
(A) at least one stationary video display for displaying a first video presentation;
(B) a moveable video display for displaying a second video presentation;
(C) a positioning mechanism coupled to the moveable video display for moving the moveable video display; and
(D) a controller in communication with the stationary video display, the moveable video display and the positioning mechanism, the controller being adapted to:
(a) show the first video presentation on the stationary video display;
(b) show the second video presentation on the moveable video display;
(c) move the moveable video display; and
(d) stop the moveable video display, wherein in combination the stationary video display and the stopped moveable video display indicate a game outcome.

25. The gaming device of claim 24, wherein a player input device is in communication with the controller, the player input device being configured to determine where the moveable video display stops.
